(19) United States
(12) Patent Application Publication
(10) Pub. No.: US 2019/0208774 A1
(43) Pub. Date: Jul. 11, 2019

(54) Water Treatment Composition

(71) Applicant: Arch Chemicals, Inc., Allendale, NJ (US)

(72) Inventors: Deqing Lei, Alpharetta, GA (US); William Ratajczyk, Reedsburg, WI (US); Nidhi Rawat, Alpharetta, GA (US); Ryan Wersal, Alpharetta, GA (US)

(73) Assignee: Arch Chemicals, Inc., Allendale, NJ (US)

(21) Appl. No.: 16/232,551

(22) Filed: Dec. 26, 2018

Related U.S. Application Data
(60) Provisional application No. 62/614,734, filed on Jan. 8, 2018.

(51) Int. Cl. A01N 25/22; A01N 59/00; C02F 1/50; B01D 19/04

(52) U.S. Cl. CPC A01N 25/22; A01N 59/00; C02F 2103/007; B01D 19/0409; C02F 2303/04; C02F 1/50

(57) ABSTRACT

The present invention relates to a stabilized water treatment composition, containing (i) an effective amount of a hydrogen peroxide source, (ii) a first stabilizing agent, and (iii) a second stabilizing agent; which is essentially free of any peracid-based compounds, derivatives or salts thereof. A method for the using the stabilized water treatment composition to kill or to inhibit the growth of microorganisms such as gram positive or gram negative bacteria, algae, cyanobacteria, viruses, fungi, mildew, mold or combinations thereof, for various water sources such as streams, ponds, lakes, recirculating water systems, surface water, and any other suitable or desirable water sources is also described.

### CROSS-REFERENCE TO RELATED APPLICATIONS

The present application is based upon and claims priority to U.S. Provisional Application Ser. No. 62/614,734, filed on Jan. 8, 2018, which is incorporated herein by reference.

### FIELD OF INVENTION

The disclosure relates to a stabilized water treatment composition containing a hydrogen peroxide source, a first stabilizing agent and a second stabilizing agent; whereby the composition is essentially free of any peracid-based compounds, derivatives or salts thereof.

### BACKGROUND OF THE INVENTION

Aquatic environments, such as lakes, ponds and canals, are frequently subject to excessive plant growth, including algae and cyanobacteria, which blocks the circulation of water and leads to water stagnation. As fertilizers and growth promoters wash into the water from agricultural land, the problem becomes more severe as plant growth increases. Other aqueous environments, such as swimming pools, shower rooms and water storage tanks are often polluted by algal growth, which affects the color of the water and can be harmful to water users and those near water containing algae and cyanobacteria. Algae and cyanobacteria grow or bloom in lakes, ponds and other bodies of water, which can be particularly harmful due to the toxins released by some species. These released toxins can be harmful to aquatic life in the body of water and animals and/or humans which may be near the body of water or venture into the body of water. In addition, algae and cyanobacteria often deprives users of the body of water from enjoying the body of water recreationally and commercially, since either species can make the body of water unusable for recreational uses, such as boating, swimming and/or fishing, or for commercial uses such as irrigation water, fishing and the like.

It is of particular importance, that the herbicide or algaecide be capable of controlling growth or destroying a plant, algae or cyanobacteria population without harming the environment. For example, ideally an herbicide or algaecide will control plant, algae or cyanobacteria growth without having significant long-term adverse impacts on non-target organisms in the environment.

Peracetic acid and peracid-based compounds are increasingly used as biocides in various fields owing to their broad biocidal efficacy and excellent environmental profiles for water sources, such as industrial and municipal water treatment applications. Despite its use, the disadvantages of using peracid components for water treatment include its strong, pungent acrid odor; unstable nature of peracids, and higher cost.

Other disadvantages include factors such as pH and temperature, which influence peractetic acid activity. For example, peracetic acid is more effective when the pH value is 7, than at a pH range between 8 and 9. At a temperature of 15° C. and a pH value of 7, five times more peracetic acid is required to affectively deactivate pathogens than at a pH value of 7 and a temperature of 35° C.

Over the years, hydrogen peroxide source-based solutions without peracid compounds have been used in various applications, for bleaching, oxidizing, disinfecting, and cleaning a variety of surfaces ranging from skin, hair, and mucous membranes, contact lenses to household, water and industrial surfaces and instruments. However, one current drawback, is the quick decomposition of hydrogen peroxide source-based solutions, into oxygen gas and water over an extremely short time; which occurs when contacted to metal ions such as iron, copper, manganese, chromium or etc., heat and light, and pH varying solutions. This catalytic reaction of the decomposition of such solutions, results in a reduction in the efficacy, stability and overall function of the solution. For example, the rate at which such dilute hydrogen peroxide solutions decompose is greatly accelerated dependent upon factors such as pH; moderately elevated temperatures and the presence of trace amounts of various metal impurities, as mentioned.

To prevent this, many stabilizers such as stannate salts, pyrophosphates, various aromatic compounds and etc., have be used to reduce or eliminate the decomposition hydrogen peroxide source compositions, due to trace impurities; heat and etc. However, many of the previously suggested compounds have various issues and challenges associated with them, such as toxicity, environmental impact and poor performance limitations. For example, certain stabilizers designed to prevent the decomposition of hydrogen peroxide in the presence of copper and iron ions, result in only preventing the decomposition of hydrogen peroxide in the presence of metal ion, iron, such as taught in U.S. Pat. No. 4,059,678.

Therefore, there still exists a need to stabilize hydrogen peroxide source, without one or more of the aforementioned drawbacks and disadvantages, which is effective as a water treating composition to control plant growth, including algae and/or cyanobacteria, in aquatic environments, such as lakes, ponds, streams, canals, recirculating water systems, and the like.

Surprisingly, it has been discovered that when used synergistically, a combination of stabilizers significantly improve the stability of a hydrogen peroxide source, which is essentially free of peracid based compounds, derivatives or salts thereof. Furthermore, the present disclosure provides an answer to this need of providing a stabilized water treatment composition containing a hydrogen peroxide source by using two stabilizing agents, without the drawbacks of peracid-based compounds, derivatives or salts thereof.

### SUMMARY OF THE INVENTION

In one aspect, the present invention provides a stabilized water treatment composition comprising:

(i) an effective amount of a hydrogen peroxide source,
(ii) a first stabilizing agent which comprises picolinic acid, a compound having the Formula (IA) or Formula (IB):

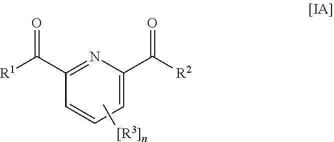

or a salt thereof;

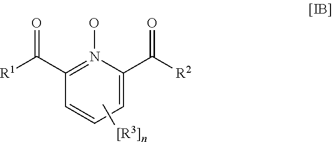

or a salt thereof;

wherein
R¹ is OH or —NR^{Ia}R^{Ib}, wherein R^{Ia} and R^{Ib} are independently hydrogen or (C₁-C₆) alkyl;
R² is OH or —NR^{2a}R^{2b}, wherein R^{2a} and R^{2b} are independently hydrogen or (C₁-C₆) alkyl;
each R³ is independently (C₁-C₆) alkyl, (C₂-C₆) alkenyl or C₂-C₆) alkynyl; and n is a number from zero to 3; and
   (iii) a second stabilizing agent, comprising a compound having the following Formula (IIA) or Formula (IIB):

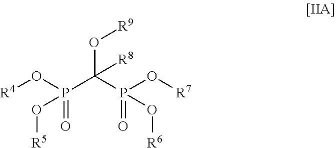

or salt thereof;

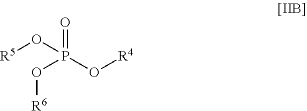

or salt thereof:

wherein
R⁴, R⁵, R⁶, and R⁷ are each independently hydrogen, (C₁-C₆) alkyl, (C₂-C₆) alkenyl or (C₂-C₆) alkynyl, (C₆-C₂₀) aryl, or X; wherein X is lithium, sodium, potassium or any combinations thereof;
R⁸ is (C₁-C₆) alkyl, (C₂-C₆) alkenyl or (C₂-C₆) alkynyl; and
R⁹ is hydrogen, (C₁-C₆) alkyl, (C₂-C₆) alkenyl or (C₂-C₆) alkynyl; and
   wherein said composition is essentially free of any peracid-based compounds, derivatives or salts thereof.

In another embodiment, the stabilized water treatment composition the composition is completely free of any peracid-based compounds, derivatives or salts thereof.

In one embodiment, the hydrogen peroxide source comprises a hydrogen peroxide solution, sodium percarbonate, potassium percarbonate, sodium perborate, potassium perborate, hydrogen peroxide urea or peroxide salts, or combinations thereof; and wherein the concentration of the hydrogen peroxide source is from 3% to about 50 w/w % of the total weight of the composition.

In one particular embodiment, the first stabilizing agent comprises a pyridine carboxylic acid or salts thereof; and in another embodiment, the second stabilizing agent is 1-hydroxyethane-1,1-diphosphonic acid (HEDP) or a salt thereof.

In one embodiment, the first or the second stabilizing agent can be used at any varied concentrations.

In one embodiment, the first stabilizing agent is present in an amount from about 0.01% to about 2 w/w %, based on the total weight of said composition.

In one embodiment, the second stabilizing agent is present in an amount from about 0.01% to about 20 w/w %, based on the total weight of said composition.

In another embodiment, the composition may further comprise the addition of other additives to the water treating composition of the present disclosure, to further provide the composition with suitable properties for end-use applications.

In a particular embodiment, the composition further comprises a second biocidal agent, wherein the second biocidal agent is present from about 0.1% to about 25 w/w % of the total composition; and wherein the second biocidal agent is essentially free of a peracid-based compounds, derivatives or salts thereof.

In one embodiment of the composition, the hydrogen peroxide source is stabilized having at least 90% stability the hydrogen peroxide active after about 30 days of storage, at a temperature of about 45° C.

Another embodiment provides a ready to use composition of the stabilized water treatment composition, wherein the composition is diluted for treating a water source by killing, inhibiting, eliminating, or controlling the growth of one or more micro-organisms therein, and/or to reduce the number of live micro-organisms therein.

Another aspect of the present invention provides a method of treating surface water for reducing the concentration of microbes in the water, said method comprises adding an effective amount of the stabilized water treating composition, according to the present invention, to the water to be treated, in an amount sufficient to kill majority of the microbes located in the water being treated.

In one embodiment, the stabilized water treatment composition provides a method to killing, inhibiting, destroying or controlling the growth of microorganisms comprising gram positive or gram negative bacteria, algae, cyanobacteria, viruses, fungi, mildew, mold or combinations thereof, for water applications comprising surface water, recirculating water systems, or any suitable or other desirable water sources.

One particular embodiment provides a method of using the stabilized water treatment composition to inhibit or kill the cyanobacterium, Microcystis aeruginosa, and the like. These and other aspects will become apparent when reading the detailed description of the invention.

### DETAILED DESCRIPTION

It has now been surprisingly found that hydrogen peroxide sources can be stabilized using two specific stabilizing agents at specific ratios resulting in superior stability of the hydrogen peroxide active ingredient during storage, and that the resulting composition is effective as a water treating composition. One unique aspect of the present invention is that a composition containing hydrogen peroxide actives, which is essentially free of any peracid-based compounds, derivatives or salts thereof, can be as effective as compositions containing peracid compounds and free of any drawbacks that peracids sources provide. The elimination of any peracid sources from hydrogen peroxide source have also shown to be equally efficacious in the inhibition of algae and cyanobacteria as further described.

Furthermore, one embodiment provides the use of such compounds in combination with a hydrogen peroxide source for the treatment of water sources such as lakes, ponds, pools, streams, canals, cooling towers, recirculating water systems, recycled water, and any other suitable or desirable fresh or sea water source that is frequently subject to excessive plant growth, including algae, cyanobacteria, and the like. This embodiment provides a method of disinfecting, treating, killing, controlling, or removing a water source containing such microorganisms by contacting the water source with an effective amount of the stabilized water treatment composition, to kill a majority of the microbes, is further described.

The term “essentially free” refers to a composition, mixture, or ingredient that does not contain a particular compound or to which a particular compound or a particular compound-containing compound has not been added. Should the particular compound be present through contamination and/or use in a minimal amount of a composition, mixture, or ingredients, the amount of the compound shall be less than about 1 w/w %.

The term “alkyl” includes a straight or branched saturated aliphatic hydrocarbon chain having from C₁-C₂₂ atoms, such as, for example, methyl, ethyl, propyl, isopropyl (1-methylethyl), butyl, tert-butyl (1,1-dimethylethyl), and the like. The term “alkyl” or “alkyl groups” also refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g. cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), or alkyl-substituted alkyl groups (e.g., alkyl-substituted cycloalkyl groups and cycloalkyl-substituted alkyl groups).

The term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

The term “alkenyl” includes an unsaturated aliphatic hydrocarbon chain having from C₂-C₁₂ atoms, such as, for example, ethenyl, 1-propenyl, 2-propenyl, 1-butenyl, 2-methyl-1-propenyl, and the like. The alkyl or alkenyl can be terminally substituted with a heteroatom, such as, for example, a nitrogen, sulfur, or oxygen atom, forming an aminoalkyl, oxyalkyl, or thioalkyl, for example, aminomethyl, thioethyl, oxypropyl, and the like. Similarly, the above alkyl or alkenyl can be interrupted in the chain by a heteroatom forming an alkylaminoalkyl, alkylthioalkyl, or alkoxyalkyl, for example, methylaminoethyl, ethylthiopropyl, methoxymethyl, and the like.

The term “alicyclic” includes any cyclic hydrocarbyl containing from C₃-C₈ atoms. Examples of suitable alicyclic groups include cyclopropanyl, cyclobutanyl, cyclopentanyl, and the like.

The term “heterocyclic” includes any closed ring structures analogous to carbocyclic groups in which one or more of the carbon atoms in the ring is an element other than carbon (heteroatom), for example, a nitrogen, sulfur, or oxygen atom. Heterocyclic groups may be saturated or unsaturated. Examples of suitable heterocyclic groups, for example, include, but are not limited to aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan. Additional examples of suitable heterocyclic groups include groups derived from tetrahydrofurans, furans, thiophenes, pyrrolidines, piperidines, pyridines, pyrrols, picoline, coumaline, and the like.

The term “aryl” includes aromatic hydrocarbyl, including fused aromatic rings, such as, for example, phenyl, naphthyl, and the like.

The term “heteroaryl” includes heterocyclic aromatic derivatives having at least one heteroatom such as, for example, nitrogen, oxygen, phosphorus, or sulfur, and includes, for example, furyl, pyrrolyl, thienyl, oxazolyl, pyridyl, imidazolyl, thiazolyl, isoxazolyl, pyrazolyl, isothiazolyl, and the like.

The term “heteroaryl” also includes fused rings in which at least one ring is aromatic, such as, for example, indolyl, purinyl, benzofuryl, and the like.

The term “salts thereof” in Formula (IA), (IB), (IIA) or (IIB) refer to metal salts; wherein the metal refers to a Group IA metal or a Group 2A metals or a mixture of Group IA metal or Group 2A metals. Exemplary metals include lithium, sodium, potassium or any combinations thereof, and the like.

In accordance with the present invention, a stabilized water treating composition is provided, comprising
(i) an effective amount of a hydrogen peroxide source,
(ii) a first stabilizing agent which comprises picolinic acid, a compound having the Formula (IA) or Formula (IB):

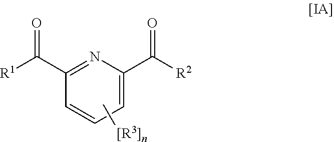

or a salt thereof;

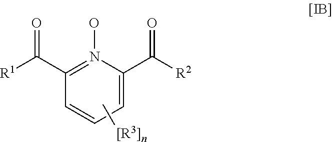

or a salt thereof;

wherein
R¹ is OH or —NR^{Ia}R^{Ib}, wherein R^{Ia} and R^{Ib} are independently hydrogen or (C₁-C₆) alkyl;
R² is OH or —NR^{2a}R^{2b}, wherein R^{2a} and R^{2b} are independently hydrogen or (C₁-C₆) alkyl;
each R³ is independently (C₁-C₆) alkyl, (C₂-C₆) alkenyl or (C₂-C₆) alkynyl; and
n is a number from zero to 3; and
(iii) a second stabilizing agent, comprising a compound having the following Formula (IIA) or Formula (IIB):

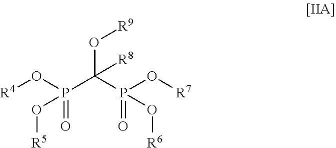

or salt thereof;

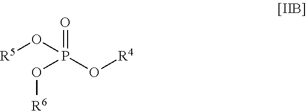

or salt thereof;

wherein
R⁴, R⁵, R⁶, and R⁷ are each independently hydrogen, (C₁-C₆) alkyl, (C₂-C₆) alkenyl or (C₂-C₆) alkynyl, (C₆-C₂₀) aryl; or X; wherein X is metal selected from Group IA metal or a Group 2A metals or a mixture of Group IA metal or Group 2A metals.
R⁸ is (C₁-C₆) alkyl, (C₂-C₆) alkenyl or (C₂-C₆) alkynyl; and
R⁹ is hydrogen, (C₁-C₆) alkyl, (C₂-C₆) alkenyl or (C₂-C₆) alkynyl; and
wherein the composition is essentially free of any peracid-based compounds, derivatives or salts thereof.

Suitably, R⁴, R⁵, R⁶, and R⁷, as shown in Formula (IIA) or (IIB), are each independently hydrogen.

Desirably, R⁴, R⁵, R⁶, and R⁷, as shown in Formula (IIA) or (IIB), is X; wherein X is a Group IA or IIA metal Exemplary metals include, but are not limited to, lithium, sodium, potassium or any combinations thereof, and the like.

Typically, R⁸ and R⁹ are each a (C₁-C₆) alkyl group.

Desirably, the stabilized water treatment composition, as described above, is completely free of any peracid-based compounds, derivatives or salts thereof.

Typically, the alkyl, alkenyl, alicyclic groups, and heterocyclic groups can be unsubstituted or substituted. Examples include, but are not limited to aryl, heteroaryl, (C₁-C₄) alkyl, (C₁-C₄) alkenyl, (C₁-C₄) alkoxy, amino, carboxy, halo, nitro, cyano, —SO₃H, phosphono, or hydroxyl group, and the like. Suitably, if the alkyl, alkenyl, alicyclic group, or heterocyclic group is substituted, the substitution may be a (C₁-C₄) alkyl, halo, nitro, amido, hydroxy, carboxy, sulpho, or phosphono, and the like. Desirably, the alkyl group is an alkyl substituted with a hydroxyl group.

Typically, the aryl and heteroaryl groups can be unsubstituted or substituted on the ring. Examples include, but are not limited to, aryl, heteroaryl, alkyl, alkenyl, alkoxy, amino, carboxy, halo, nitro, cyano, —SO₃H, phosphono, or hydroxyl group. Suitably, if the aryl, aralkyl, or heteroaryl is substituted, the substitution may be a (C₁-C₄) alkyl, halo, nitro, amido, hydroxy, carboxy, sulpho, or phosphono. Desirably, the aryl group is an aryl substituted with (C₁-C₄) alkyl.

The stabilizing agents are normally added to hydrogen peroxide solutions to combat decomposition due to trace impurities, mainly dissolved metals, heat and various pH conditions. The addition of a stabilizer(s) serves to prevent the components, in the biocidal composition, from decomposing on the shelf prematurely during storage of the formulations. For example, the addition of a stabilizer is used to deactivate impurities that may cause decomposition of a hydrogen peroxide source in a formulation.

Suitably, at least one or more types of stabilizers are used in the stabilized water treatment composition. The first and second stabilizing agents act synergistically to delay or prevent the hydrogen peroxide source within the composition decomposing during storage, packaging, or transportation.

Without wishing to be bound by any particular theory, it is thought that in addition to functioning as a stabilizer through the chelating of transition metal ions, phosphonic acid based stabilizers such as HEDP, also act as an acid catalyst and aid in the formation of the peroxycarboxylic acid from the corresponding carboxylic acid and hydrogen peroxide. It is thought that by using two different types of stabilizers, the transition metals responsible for the catalytic decomposition of peroxycarboxylic acids are more efficiently deactivated by forming a more stable complex(es) involving both chelators.

Suitably, the first stabilizing agent is a pyridine carboxylic acid based or salts thereof, and the like (specifically 2,6-pyridinedicarboxylic acid also known as DPA or 2,6-Dipicolinic acid). Typically, the first stabilizer is present in a concentrate from about 0.01% to about 2 w/w %. Suitably, the first stabilizer is present in a concentrate from about 0.05% to about 2 w/w %; and desirably from about 0.1% to about 1.0 w/w %.

Suitably, the second stabilizing agent is 1-hydroxy ethylidene-I,I-diphosphonic acid (HEDP or etidronic acid), or a salt thereof. Typically, salts of HEDP may include, but not limited to sodium etidronate, disodium etidronate (1-Hydroxyethanediphosphonic acid, sodium salt), dilithium etidronate, dipotassium etidronate, trisodium etidronate, tetrasodium etidronate, tetrapotassium etidronate or combinations thereof, and the like.

Typically, the second stabilizing agent has a concentration from about 0.1% to about 20 w/w %. Suitably, the second stabilizing agent is present in a concentrate from about 0.1% to about 10 w/w %; and desirably, the second stabilizing agent is present in a concentrate from about 0.2% to about 2 w/w %.

The first or the second stabilizing agent can be used at any varied concentration. For example, the first stabilizer is present in a concentrate from about 0.01% to about 2 w/w %; and typically, the second stabilizing agent is present in an amount from about 0.1% to about 20 w/w %.

Typically, the addition of HEDP may be up to about 20 w/w % concentration would function to stabilize the hydrogen peroxide source in the present invention and simultaneously to function as a corrosion inhibitor. The corrosion inhibition properties of HEDP prevent the corrosion of the present invention when used in water treatment applications.

Examples of the hydrogen peroxide source may include, but not limited to, a hydrogen peroxide solution, sodium percarbonate, potassium percarbonate, sodium perborate, potassium perborate, hydrogen peroxide urea or peroxide salts, or combinations thereof; and wherein the concentration of the hydrogen peroxide source is from 3% to about 50 w/w % of the total weight of the composition.

For example, in one embodiment, the hydrogen peroxide source is a concentrated solution containing about 5% to about 37 w/w % of a hydrogen peroxide source dissolved in water; and in another embodiment, the hydrogen peroxide source is concentrated solution containing about 7% to about 35 w/w % of a hydrogen peroxide source dissolved in water.

Suitably, the hydrogen peroxide source is a hydrogen peroxide solution; and desirably, the hydrogen peroxide source is a solid formulation of sodium percarbonate.

Suitably, the present invention provides a stabilized water treatment composition essentially free of any peracid-based compounds, mixtures of peracids, such as (C₁-C₂₄) sulfoperoxycarboxylic acids, percarboxylic acids, peroxyacid, peroxycarboxylic acid or derivatives or salts thereof, and the like. Examples include, but not limited to, acetic acid, propionic acid, butyric acid, peroxyformic, peroxy acetic, peroxypropionic, peroxybutanoic, and the like. Desirably, the stabilized water treatment composition is completely free of any peracid-based compounds, derivatives or salts thereof.

The water treatment composition may further comprise one or more of an additive to the stabilized water treating composition disclosed, to further provide the composition with suitable properties for end-use applications. Typical examples include, but are not limited to, solvents, corrosion inhibitors, emulsifiers, fragrances, dyes, preservatives, anti-foaming agents, thickening agents, hydrotropes agents, second biocide, sequestering agent, aid stabilizing solubilizer, aqueous solvent or mixtures thereof; and the like.

Typically, the addition of an aqueous solvent may be used. Examples of aqueous solvent include, but not limited to, water, aqueous alcohols, ammonia water, acid solutions, salt solutions, water-miscible organic solvents, combinations thereof, and the like. Suitably, the solvent used is water or an aqueous alcohol.

Examples of aqueous alcohols include, but not limited to, methanol, ethanol, propanol, benzyl alcohol, phenoxyethanol, isopropanol, ethylene glycol, propylene glycol or mixtures thereof, and the like.

Examples of water-miscible organic solvents include, but not limited to, alkyl and dialkly glycol ethers of ethylene glycol or propylene glycol, such as diethylene glycol propyl ether, ethylene glycol monomethyl ether, ethylene glycol monoethyl ether, ethylene glycol monopropyl ether, ethylene glycol monoisopropyl ether, ethylene glycol monobutyl ether, diethylene glycol monomethyl ether, diethylene glycol monobutyl ether, diethylene glycol monoethyl ether, diethylene glycol mono-n-butyl ether, ethylene glycol dimethyl ether, ethylene glycol diethyl ether, ethylene glycol dibutyl ether, propylene glycol n-butyl ether, tripropylene glycol methyl ether, dipropylene glycol methyl ether, or dipropylene glycol butyl ether, combinations thereof, and the like.

Alternately, the addition of a sequestering agent may be included in the stabilized water treating composition. The addition of a sequestering agent is used during dyeing for removing hardness of water. Sequestering agents combine with calcium and magnesium ions and other heavy metal ions in hard water.

Examples of sequestering agents include, but not limited to, aminocarboxylic acid base products, phosphates and phosphonates, hydroxycarboxylates, polyacrylates, sugar acrylates, polymeric clarifiers, dichlor, cyanuric acid, combinations thereof, and the like. Suitably, the sequestering agent may be present from about 0.1% to about 5 w/w % of the total composition.

Examples of phosphates sequestering agents include inorganic polyphosphates such as sodium hexametaphosphate (SHMP), sodium polyphosphate, sodium tripolyphosphate, sodium trimetaphosphate, sodium pyrophosphates, combinations thereof, and the like.

Examples of phosphonate sequestering agents include phosphonated aminopolycarboxylates such as ethylenediamine tetra(methylene phosphonic acid) (EDTMP), Diethylene Triamine Penta Methylene Phosphonic Acid (DETMP), aminotris (methylenephosphonic acid) (ATMP), diethylenetriamine penta (methylene phosphonic acid) (DTPMP), HEDP or salts thereof; combinations thereof, and the like.

Typically, the addition of a substance to aid the solubilizing the first stabilizer or second stabilizer may be used in an amount from about 0.1% to 5 w/w % of the total composition.

Examples of exemplary substances that can aid solubilization of the first and/or second stabilizing agent(s) include, but are not limited to, hydrotropes such as sodium xylene sulfonate, sodium cumene sulfonates; and surfactants, such as anionic surfactants and noinionic surfactants, combinations thereof, and the like.

Examples of exemplary anti-foaming agent include, but not limited to, silicon based (polydimethylsiloxane, Orco Antifoam AFB™, Andifoam-DF series; Foam Blast or Masil series by Emerald Performance materials; SAF series by Silchem Inc.; Silfar series by Wacker Chemical Corp.; or etc.), alkyl poly acrylates, castor oil, fatty acids, fatty acids esters (saturated or unsaturated C₄-C₂₂ atoms; polymerized C₄-C₂₂ fatty acid esters), mineral oils, fatty acids sulfate, fatty alcohols (C₁₂-C₃₀ monohydric to trihydric alcohols C₄-C₂₂ atoms monohydric to trihydric alcohols), fatty alcohol esters (dihydric or trihydric alcohols of C₁₂-C₂₂ atoms; polyoxypropylated or ethoxylated glycerol; saturated or unsaturated C₄-C₂₂ atoms), fatty alcohol sulfate, foot olive oil, mono & diglyceride, paraffin oil, paraffin wax, polypropylene glycol, vegetable oil (cottonseed oil or etc.), polyols, polyglycerol fatty acid esters of C₄-C₂₂ atoms, combinations thereof, and the like.

Suitably, the anti-foaming agent comprises polydimethylsiloxane, (Trade name SAG 710 antifoam); wherein the optional anti-foaming agent may be present in an amount from about 0.01% to about 5 w/w % of the total composition.

Typically, the second biocidal agent may be added to the present invention, essentially free or completely free of any peracid-based compounds, derivatives or salts thereof. The use of an additional biocidal agent may be included in the compositions and/or methods of the invention for enhanced biocidal efficacy, in an amount sufficient to kill or to inhibit the growth of microorganisms.

Suitably, the second biocidal agent is essentially free of a peracid-based compounds, derivatives or a salt thereof; and desirably, the second biocidal agent is completely free of a peracid-based solution, derivatives or a salt thereof.

The second biocidal agents may be employed in amounts sufficient to provide antimicrobial efficacy, as may vary depending upon the water source in need of treatment and the contaminants therein. Suitably, the second biocidal agent is present from about 0.1% to about 25 w/w % of the total composition.

Examples of a second biocidal agents including, but not limited to, halogen-releasing compound; quaternary ammonium compounds (include quaternary ammonium halides, sulfate, phosphate, nitrate, or combinations thereof; such as benzylalkonium chloride), isothiazolones or mixtures thereof, pyrithiones, glutaraldehyde, Iodopropynyl butylcarbamate (IPBC), polyhexamethylene biguanide (PHMB), bronopol, amines (such as Bis (3-aminopropyl) dodecylamine), metal salts, poly(oxyethylene (dimethylimino) ethylene (dimethylimino) ethylene dichloride), sodium dimethyldithiocarbamate, 2-chloro-4,6-bis(ethylamino)-5-triazine, combinations thereof, and the like.

Examples of halogen-releasing compounds include, but not limited to, chlorinated isocyanuric acids or salts thereof, isothiazolinone or a mixture of isothiazolinones; halogenated hydantoins, hypochlorous acids or salts thereof, chlorine gas, chlorine dioxide, hypobromite salts, hypobromous acid; and compatible combinations thereof and the like; essentially free of any peracid-based solutions, derivatives or salts thereof.

Examples of chlorinated isocyanuric acids or salts thereof, include but not limited to, such as, trichloroisocyanuric acid (TCCA), and dichloroisocyanuric acid (DCCA); dichloroisocyanurate salts (e.g. sodium dichloroisocyanurate, potassium dichloroisocyanurate), trichloroisocyanurate and (e.g. sodium or potassium trichloroisocyanurate), combinations thereof, and the like.

Examples of chlorinated halogenated hydantoins include both chlorine and bromine-containing hydantoins such as bromochlorodimethylhydantoin (BCDMH); dibromodimethylhydantoin (DBDMH), dichlorodimethylhydantoin (DCDMH), dichloromethylethylhydantoin (DCMEH), combinations thereof, and the like.

Examples of hypochlorite salts; hypochlorous or hypobromous acid and salts thereof include, but not limited to, lithium hypochlorite, sodium hypochlorite, potassium hypochlorite, magnesium hypochlorite, calcium hypochlorite, combinations thereof, and the like.

Examples of metal salts include, but are not limited to, zinc chloride, zinc oxide, aluminum sulfate, copper sulphate, copper citrate, copper EDTA (ethylene diaminetetraacetic acid), copper gluconate, colloidal silver, silver nitrate, potassium monopersulfate, sodium perborate, sodium percarbonate, combinations thereof, and the like.

Suitably, the present invention is directed to using exemplary stabilizing agent for storing the stabilized water treatment composition containing a hydrogen peroxide source. For example, wherein said composition retains at least about 90% of the hydrogen peroxide activity after about 30 days of storage at about 45° C.; alternatively, the composition retains at least about 95% of the hydrogen peroxide activity after about 30 days of storage at about 45° C. Desirably, the composition retains at least about 99% of the hydrogen peroxide activity after about 30 days of storage at about 45° C.

In another aspect of the present invention, the stabilized water treatment composition may be used to treat various water sources such as industrial liquid systems, industrial water systems, liquid process streams, industrial liquid process streams, industrial process water systems, process water applications, process waters, utility waters, recirculating water systems, recreational water systems, water used in manufacturing, water used in industrial services, aqueous liquid streams, liquid stream, poultry (such as animal drinking water, carcass washing, and the like), wastewater, oil and gas, aquaculture; and the like. Examples include, but are not limited to, swimming pools, ponds, lakes, spas, streams, canals, and any body of water (fresh or salt water source), that is frequently subject to excessive plant growth, including algae, cyanobacteria, and the like.

Alternately, the present invention provides a method of using the water treatment composition to kill or to inhibit the growth of microorganisms such as gram positive or gram negative bacteria, algae, cyanobacteria, viruses, fungi, mildew, mold or combinations thereof and the like; for water systems comprising surface water as well as recirculating water systems, and any suitable or other desirable water sources. For example, the present methods can be used to treat fresh water, pond water, sea water, produced water, and a combination thereof. Suitably, the water treatment composition may be used to kill or to inhibit the growth of microorganisms in surface water.

The water treatment composition is used to disinfect, kill or inhibit microorganisms present in a water source, as listed in the examples above. Microorganisms may include, but not limited to, gram positive and gram negative bacteria, viruses, fungi, mildew, yeast, algae, cyanobacteria, and mold. Examples of such microorganisms include, but are not limited to, cyanobacterium (e.g. Microcystis aeruginosa, and the like), Staphylococcus species, Bacillus species, Pseudomonas, hepatitis, rotavirus, rhinovirus, or Mycobacterium terrae; other analogous microorganisms and unicellular organisms (e.g., phytoplankton and protozoa), and the like.

In one aspect, the compositions has improved microbial efficacy against S. aureus, E. coli, Candida albicans, Aspergillus niger, P. aeruginosa, B. mycoides, A. niger, Bacillus subtilis, Clostridia sp., Klebsiella pneumoniae, Legionella pneumophila, Enterobacter sp., Serratia sp., Desulfovibrio sp., and Desulfotomaculum sp., Cephalosporium acremonium, Penicillium notatum, and Aureobasidium pullulans, Chlorella vulgaris, Euglena gracilis, and Selenastrum capricornutum, and C. pyrenoidosa; especially Mycobacterium terrae.

Suitably, the stabilized water treatment composition is used to disinfect, kill or inhibit algae in water systems as defined above. For example, the stabilized water treatment composition was used to inhibit the cyanobacterium, Microcystis aeruginosa, as indicated in examples 3 and 4.

Suitably, the stabilized water treatment composition is used to treat a water source and is added to the water source is such that there is from about 1 ppm to 1000 ppm of a hydrogen peroxide source. Desirably, the stabilized water treatment composition is used to treat a water source and is added to the water source such that there is from about 1 ppm to 100 ppm of a hydrogen peroxide source. Desirably the water source is surface water.

In another aspect the present invention provides a method of treating a water source includes the use of the stabilized water treatment composition in a diluted ready-to-use composition to inhibit growth of one or more micro-organisms therein and/or to reduce the number of live micro-organisms therein.

While the invention has been described above with references to specific embodiments thereof, it is apparent that many changes, modifications and variations can be made without departing from the invention concept disclosed herein. Accordingly, it is intended to embrace all such changes, modifications, and variations that fall within the spirit and broad scope of the appended claims.

The following examples illustrate the invention without limitation. All parts and percentages are given by weight unless otherwise indicated.

It will be understood that each of the elements described in the examples below, or two or more together may also find a useful application in other types of methods differing from the type described above. Without further analysis, the foregoing will so fully reveal the gist of the present disclosure that others can, by applying current knowledge, readily adapt it for various applications without omitting features that, from the standpoint of prior art, fairly constitute essential characteristics of the generic or specific aspects of this disclosure set forth in the appended claims.

The foregoing embodiments are presented by way of example only; the scope of the present disclosure is to be limited only by the following claims.

### Example 1

Several water treatment compositions were prepared as shown in Table 1. Hydrogen peroxide concentrate (Arkema); HEDP, DPA, EDDS, D-sorbitol (Aldrich); and deionized water used to total each composition to 100%. Solution J is a commercial sample used as a control to show unstable properties without stabilizers. Each composition is prepared by diluting 50% hydrogen peroxide solution with water, to achieve the desired amounts shown below. Similarly the additives listed are diluted to represent the values below.

TABLE 1
(Compositions with various stabilizers)

| Component | Sol A | Sol B | Sol C | Sol D | Sol E | Sol F | Sol G | Sol H | Sol I | Sol J |
|---|---|---|---|---|---|---|---|---|---|---|
| H2O2 | 27.60% | 27.60% | 27.50% | 27.60% | 27.60% | 27.50% | 27.50% | 27.50% | 27.50% | 23.00% |
| HEDP | — | — | 0.24% | — | — | 0.12% | — | 0.13% | 0.10% | — |
| DPA | — | — | — | — | 0.25% | 0.11% | 0.11% | — | 0.10% | — |
| EDDS | — | — | — | 0.21% | — | — | 0.12% | 0.10% | — | — |
| D-sorbitol | — | 0.21% | — | — | — | — | — | — | — | — |
| PAA | — | — | — | — | — | — | — | — | — | 5.30% |
| AA | — | — | — | — | — | — | — | — | — | 10.00% |
| Water | 72.40% | 72.19% | 72.26% | 72.19% | 72.15% | 72.27% | 72.27% | 72.27% | 72.30% | 61.70% |
| Total (w/w) | 100% | 100% | 100% | 100% | 100% | 100% | 100% | 100% | 100% | 100% |

PAA: peracetic acid; DPA: dipicolinic acid; AA: acetic acid; EDDS: ethylenediamine-N-N-disuccinic acid.

Each solution was prepared by adding the ingredients listed above whereby there sample was stirred for about 15 minutes at room temperature (22-26° C.), after which the solution was stirred in a HDPE container. Solutions containing multiple stabilizers were added sequentially and stirred for about 5 minutes with each addition.

### Example 2

TABLE 2
(Hydrogen peroxide stability test at 45° C.)

| | |
|---|---|
| H₂O @ | 30 days @ 45° C. |

| | 0 days | % H₂O loss | % H₂O₂ loss |
|---|---|---|---|
| Sol A | 27.4 | 22.2 | −18.98 |
| Sol B | 27.2 | 24.8 | −8.82 |
| Sol C | 27.2 | 26.9 | −1.1 |
| Sol D | 27.1 | <0.05 | −99.82 |
| Sol E | 27.3 | 26.8 | −1.83 |
| Sol F | 27.2 | 27.1 | −0.37 |
| Sol G | 27.2 | 9.4 | −65.44 |
| Sol H | 27.2 | 26.9 | −1.1 |
| Sol I | 27.6 | 27.5 | −0.36 |
| Sol J | 23.1 | 7.7 | −66.7 |

Overall stability comparison showed that without any stabilizers, the active decomposed greatly, and the addition of a specific stabilizer indicate an increase in the stability of hydrogen peroxide. For example, Solution A containing 27.5% H₂O₂ with D.I. water, lost about 19% hydrogen peroxide after about 30 days of storage at 45° C.; whereas Solutions F and I indicate synergistic stabilization of HEDP and DPA, providing the best stabilization of hydrogen peroxide, in comparison to Solutions G or H.

Combinations of HEDP or DPA with other stabilizers as shown in Solutions G and H were not as favorable either. The large loss of hydrogen peroxide in Solution G may imply that EDDS likely underwent a chemical reaction with the concentrated hydrogen peroxide. Either solution with combination stabilizers only lost about 0.1 hydrogen peroxide after about 30 days of storage at 45° C.

Solutions C and E containing either HEDP or DPA lost about 1% of hydrogen peroxide in comparison to solutions containing both stabilizers. The combinations of stabilizing agents in Solutions F and I both show consistency in the stabilization of hydrogen peroxide over an extended period of time.

Solutions B and D containing different stabilizers showed greater loss of hydrogen peroxide versus other stabilizers as shown above, showing less favorable stability results in comparison to HEDP or DPA either alone or in combination. Commercial sample of solution J showed to be very unstable, with a 66.7% loss of hydrogen peroxide after about 30 days at 45° C. Most favorable results were shown with the combination of HEDP and DPA as stabilizing agents for the hydrogen peroxide solution, with less than 0.1% of hydrogen peroxide loss after about 30 days at 45° C.

### Example 3

TABLE 3
(Algaecide efficacy testing of stabilized peroxide Solution E)

| | Cell density | In vivo Chl | In vivo Chl | Cell density | In vivo Chl | In vivo Chl | Cell density |
|---|---|---|---|---|---|---|---|
| | At 0 ppm | a conc. | a conc. | After 4 days | a concentration | a concentration | After 4 days |
| | @ 4 days | at 1.8 ppm | at 1.8 ppm | @ 0.90 ppm | at 9.2 ppm | at 9.2 ppm | @ 9.2 ppm |
| Sample | (cells/mL) | @1 day | @4 day | (cells/mL) | @1 day | @4 day | (cells/mL) |
| Sol E | 1.60E+06 | 0.34 | 0.08 | <1.0E+04 | 0.4 | 0.07 | <1.6E+04 |
| Sol J | 1.60E+06 | 0.31 | 0.05 | 1.60E+06 | 0.34 | 0.08 | <1.6E+04 |

Algal Challenge Test (ACT) against the cyanobacterium Microcystis aeruginosa: Standard ACT protocol; Initial in vivo chl a concentration of Microcystis aeruginosa=0.55 μg/L; Initial cell density=4.7E+05. Results from this testing of the stabilized hydrogen peroxide solution, showed that the composition was effective in controlling Microcystis aeruginosa at both 1.80 and 9.20 ppm hydrogen peroxide test concentrations at 1 to 4 days test period, in comparison to the commercial sample without any stabilizing agents.

### Example 4

TABLE 4
(Algaecide efficacy testing of stabilized peroxide Solution E)

| | In vivo Chl | In vivo Chl | Cell density | In vivo Chl | In vivo Chl | Cell density |
|---|---|---|---|---|---|---|
| | a conc. | a conc. | After 4 days | a concentration | a concentration | After 4 days |
| | at 0.90 ppm | at 0.90 ppm | @ 0.90 ppm | at 0.45 ppm | at 0.45 ppm | @0.45 ppm |
| | @1 day | @4 day | (cells/mL) | @1 day | @4 day | (cells/mL) |
| Sol E | 0.29 | 0.08 | <1.0E+04 | 0.34 | 0.08 | <1.0E+04 |
| Sol J | 0.27 | 0.07 | <1.0E+04 | 0.37 | 0.09 | <1.0E+04 |

Furthermore, the algaecidal activities of Solution E and J further reduced to 0.90 and 0.45 ppm H₂O₂ and tested at a lower concentration level in comparison to Table 3. Algal Challenge Test against Microcystis aeruginosa: Standard ACT protocol; Initial in vivo chl a concentration of Microcystis aeruginosa=0.51 μg/L; Initial cell density=2.8E+05. These results further demonstrate that both formulations were same effective at controlling Microcystis aeruginosa at 0.90 and 0.45 ppm levels, in comparison to a commercial sample without any stabilizing agents.

What is claimed is:

1. A stabilized water treating composition comprising
(i) an effective amount of a hydrogen peroxide source,
(ii) a first stabilizing agent which comprises picolinic add, a compound having the Formula (IA) or Formula (IB): 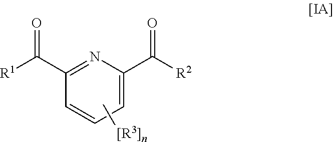
or a salt thereof; 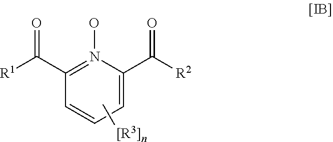
or a salt thereof;
wherein
R¹ is OH or —NR^{Ia}R^{Ib}, wherein R^{Ia} and R^{Ib} are independently hydrogen or (C₁-C₆) alkyl,
R² is OH or —NR^{2a}R^{2b}, wherein R^{2a} and R^{2b} are independently hydrogen or (C₁-C₆) alkyl;
each R³ is independently (C₁-C₆) alkyl, (C₂-C₆) alkenyl or (C₂-C₆) alkynyl; and
n is a number from zero to 3; and
(iii) a second stabilizing agent, comprising a compound having the following Formula (IIA) or Formula (IIB): 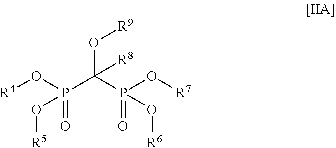
or salt thereof; 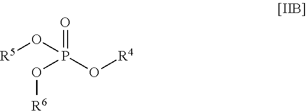
or salt thereof;
wherein
R⁴, R⁵, R⁶, and R⁷ are each independently hydrogen, (C₁-C₆) alkyl, (C₂-C₆) alkenyl or (C₂-C₆) alkynyl, (C₆-C₂₀) aryl, or X; wherein X is lithium, sodium, potassium or any combinations thereof;
R⁸ is (C₁-C₆) alkyl, (C₂-C₆) alkenyl or (C₂-C₆) alkynyl; and
R⁹ is hydrogen, (C₁-C₆) alkyl, (C₂-C₆) alkenyl or (C₂-C₆) alkynyl; and
wherein the composition is essentially free of any peracid-based compounds, derivatives or salts thereof.

2. The stabilized water treating composition, according to claim 1, wherein R⁴, R⁵, R⁶, and R⁷, having a Formula (IIA) or (IIB), are each independently hydrogen, or X;
wherein X is lithium, sodium, or potassium.

3. The stabilized water treating composition, according to claim 1, wherein R⁸ and R⁹ are each a (C₁-C₆) alkyl group.

4. The stabilized water treating composition, according to claim 1, wherein the first stabilizing agent comprises 2,6-pyridine dicarboxylic acid or salt thereof.

5. The stabilized water treating composition, according to claim 1, wherein the second stabilizing agent comprises 1-hydroxyethane-1,1-diphosphonic acid (HEDP) or a salt thereof.

6. The stabilized water treating composition, according to claim 1, wherein the hydrogen peroxide source is selected from the group comprising a hydrogen peroxide solution, sodium percarbonate, potassium percarbonate, sodium perborate, potassium perborate, hydrogen peroxide urea or peroxide salts, or combinations thereof; and wherein the concentration of the hydrogen peroxide source is from 3% to about 50 w/w % of the total weight of the composition.

7. The stabilized water treating composition, according to claim 6, wherein the hydrogen peroxide source is a hydrogen peroxide solution; and wherein the concentration of the hydrogen peroxide solution may be from about 5% to about 37 w/w %, based on the total weight of said composition.

8. The stabilized water treating composition, according to claim 7, wherein the concentration of the hydrogen peroxide solution may be from 7% to about 30 w/w %, based on the total weight of said composition.

9. The stabilized water treating composition, according to claim 1, wherein the first stabilizing agent is present in an amount from about 0.01% to about 2 w/w %, based on the total weight of said composition.

10. The stabilized water treating composition, according to claim 1, wherein the second stabilizing agent is present in an amount from about 0.01% to about 20 w/w %, based on the total weight of said composition.

11. The stabilized water treating composition, according to claim 1, wherein said composition retains at least 90% of the hydrogen peroxide source activity, after about 30 days of storage, at about 45° C.

12. The stabilized water treating composition, according to claim 1, wherein said composition retains at least 95% of the hydrogen peroxide source activity, after about 30 days of storage, at about 45° C.

13. The stabilized water treating composition, according to claim 1, further comprising an aqueous solvent, selected from a group comprising of water, aqueous alcohol, ammonia water, ethylene glycol, propylene glycol and combinations thereof.

14. The stabilized water treating composition, according to claim 1, further comprising a second biocidal agent, wherein the second biocidal agent is present from about 0.1% to about 25 w/w % of the total composition; and wherein the second biocidal agent is essentially free of a peracid-based compounds, derivatives or salts thereof.

15. The stabilized water treating composition, according to claim 1, wherein the composition is completely free of any peracid-based compounds, derivatives or salts thereof.

16. The stabilized water treating composition, according to claim 1, further comprising a sequestering agent, wherein the sequestering agent is present from about 0.1 to about 5 w/w % of the total composition.

17. The stabilized water treating composition, according to claim 1, further comprising a corrosion inhibitor, wherein the corrosion inhibitor is present from about 0.01% to 20 w/w % of the total composition.

18. The stabilized water treating composition, according to claim 1, further comprising an optional anti-foaming agent; wherein the anti-foaming agent is polydimethylsiloxane anti-foam.

19. The stabilized water treating composition, according to claim 1, wherein the hydrogen peroxide source is a hydrogen peroxide solution; the first stabilizing agent is 2,6-pyridine dicarboxylic acid or salt thereof and the second stabilizing agent is HEDP or a salt thereof.

20. A method of treating water for reducing the concentration of microbes in the water, said method comprises adding an effective amount of the stabilized water treating composition according to claim 1 to the water to be treated, in an amount sufficient to kill majority of the microbes located in the water being treated.

21. The method of treating water, according to claim 20, wherein the method comprising ready-to-use composition of the water treating composition to inhibit growth of one or more micro-organisms therein and/or to reduce the number of live micro-organisms therein.

22. The method of treating water, wherein the method comprising a composition, according to claim 1, wherein the treated water source comprises from about 1 ppm to about 1,000 ppm of a hydrogen peroxide source.

23. The method of treating water, wherein the method comprising a composition, according to claim 1, wherein the treated water source comprises from about 1 ppm to about 100 ppm of a hydrogen peroxide source

24. The method of claim 20, wherein the water is surface water and the microbes in the water comprises algae, cyanobacteria or combinations thereof.
